(19) United States
(12) Patent Application Publication
(10) Pub. No.: US 2026/0322174 A1
(43) Pub. Date: Oct. 15, 2026

(54) BATTERY CHARGING IN NON-LINE-OF-SIGHT CONFIGURATIONS

(71) Applicant: Saltenna Inc., McLean, VA (US)

(72) Inventors: Igor SMOLYANINOV, Columbia, MD (US); Quirino BALZANO, Annapolis, MD (US); Sanjee SINGLA, Washington, DC (US)

(21) Appl. No.: 19/648,848

(22) Filed: Apr. 15, 2026

Related U.S. Application Data
(60) Provisional application No. 63/789,272, filed on Apr. 15, 2025.

(51) Int. Cl. H02J 50/20; H02J 50/00

(52) U.S. Cl. CPC H02J 50/20; H02J 50/001; H02J 50/005

(57) ABSTRACT

Methods, systems, and devices for wireless power transmission in non-line-of-sight configurations are described. In some implementations, the method may include generating a radio frequency signal at a specified frequency using a signal generator connected to a plasmonic antenna configured as a transmitter. The system may induce surface electromagnetic waves along a metal surface in response to the radio frequency signal, with the surface electromagnetic waves propagating around obstacles to reach a receiver. The receiver may include a second plasmonic antenna connected to a power harvester board, which may detect the surface electromagnetic waves and convert the captured waves into direct current power. The direct current power may be stored or used to operate a load device.

### FIELD OF TECHNOLOGY

The present disclosure relates generally to wireless energy systems, and more specifically to battery charging in non-line-of-sight configurations, e.g., through metal shields and obstacles and around corners.

### BACKGROUND

Battery charging is a technology that may enable energy delivery to devices without the need for physical connections. Systems in this field may utilize various methods, such as inductive coupling, resonant coupling, or radio frequency-based transmission, to transfer energy wirelessly. These approaches may involve the generation and propagation of electromagnetic waves to deliver energy across distances. Applications of battery charging may include powering sensors, medical devices, and equipment in locations where direct physical connections are impractical or impossible.

### SUMMARY

The described techniques relate to improved methods, systems, devices, and apparatuses that support techniques for battery charging in non-line-of-sight configurations, e.g., through metal shields and obstacles and around corners. Some implementations provide a battery charging system that may utilize plasmonic antennas to induce surface electromagnetic waves capable of propagating along metal surfaces and around obstacles or corners. The system may include a transmitter, receiver, and control unit to synchronize operations, enabling efficient energy delivery in environments where conventional free-space radio frequency transmission may be ineffective. The transmitter may generate a radio frequency signal, which may be amplified and fed into a plasmonic antenna to induce surface electromagnetic waves. These waves may propagate along the surface of metal shields or obstacles, bypassing physical barriers and supplying energy to the receiver located on the opposite side.

The receiver, equipped with a plasmonic antenna, may detect the surface electromagnetic waves and convert the received signal into usable direct current energy, e.g., using a energy harvester board. The control unit may coordinate the operation of the transmitter and receiver, ensuring synchronization and optimizing battery charging efficiency. The system may be designed to operate on flexible substrates, allowing for deployment on curved or irregular surfaces, and may support applications in industrial, medical, and remote sensing fields. By overcoming the limitations of conventional systems, some implementations may enable reliable wireless energy delivery in shielded and obstructed environments, addressing critical challenges in the field.

A battery charging system configured for transferring energy in a non-line-of-sight configuration is described. The system may include a transmitter connected with a first plasmonic antenna configured to induce surface electromagnetic waves along a conductive surface. The system may include a receiver equipped with a second plasmonic antenna configured to detect the surface electromagnetic waves propagating along the conductive surface and convert the detected surface electromagnetic waves into electrical energy. The energy may be transmitted from the transmitter to the receiver in a non-line-of-sight configuration.

A method of forming a battery charging system is described. The method may include providing a transmitter connected with a first plasmonic antenna configured to induce surface electromagnetic waves along a conductive surface. The method may include providing a receiver equipped with a second plasmonic antenna configured to detect the surface electromagnetic waves propagating along the conductive surface and convert the detected surface electromagnetic waves into electrical energy. The system may be configured such that energy may be transmitted from the transmitter to the receiver in a non-line-of-sight configuration.

Some examples of the technologies and related methods described herein may further include a energy harvester electrically connected to the second plasmonic antenna. The energy harvester may be configured to store the electrical energy in an energy storage component.

In some examples of the technologies and related methods described herein, the energy storage component may comprise a battery or a capacitor.

In some examples of the technologies and related methods described herein, the second plasmonic antenna may be positioned on an opposite side of a conductive surface relative to the first plasmonic antenna.

In some examples of the technologies and related methods described herein, the conductive surface may comprise a metal shield configured to enable propagation of the surface electromagnetic waves induced by the first plasmonic antenna.

Some examples of the technologies and related methods described herein may further include a control unit electrically connected to one or both of the transmitter and/or the receiver. The control unit may be configured to synchronize operation between the first plasmonic antenna and the second plasmonic antenna.

In some examples of the technologies and related methods described herein, the control unit may be configured to adjust the frequency of the radio frequency signal generated by the transmitter.

In some examples of the technologies and related methods described herein, the first plasmonic antenna and the second plasmonic antenna may be integrated onto flexible substrates configured to conform to curved or irregular geometries.

In some examples of the technologies and related methods described herein, the first plasmonic antenna may be connected to a energy amplifier configured to increase the strength of the radio frequency signal.

In some examples of the technologies and related methods described herein, the second plasmonic antenna may be connected to a rectifier configured to convert the detected surface electromagnetic waves into direct current energy.

In some examples of the technologies and related methods described herein, the control unit may be configured to manage the operation of the RF signal generator and the energy amplifier.

In some examples of the technologies and related methods described herein, the first plasmonic antenna and the second plasmonic antenna may be configured to operate at a specified frequency.

In some examples of the technologies and related methods described herein, the conductive surface may be configured to enable the surface electromagnetic waves to travel around obstacles or corners.

Some examples of the technologies and related methods described herein may further include a energy harvester configured to directly use the electrical energy to operate a load device.

A method for battery charging in non-line-of-sight configurations is described. The method may include generating a radio frequency signal at a specified frequency using a signal generator connected to a plasmonic antenna configured as a transmitter. The method may include inducing surface electromagnetic waves along a metal surface in response to the radio frequency signal, where the surface electromagnetic waves may propagate around obstacles to reach a receiver. The method may include detecting the surface electromagnetic waves at the receiver, where the receiver may include a second plasmonic antenna connected to a energy harvester board. The method may include converting the captured surface electromagnetic waves into direct current energy, where the direct current energy may be stored or used to operate a load device.

A system configured for battery charging in non-line-of-sight configurations is described. The system may include a processor and memory coupled with the processor. The memory may store instructions executable by the processor to cause the system to generate a radio frequency signal at a specified frequency using a signal generator connected to a plasmonic antenna configured as a transmitter. The system may induce surface electromagnetic waves along a metal surface in response to the radio frequency signal, where the surface electromagnetic waves may propagate around obstacles to reach a receiver. The receiver may include a second plasmonic antenna connected to a energy harvester board. The system may detect the surface electromagnetic waves at the receiver and may convert the captured surface electromagnetic waves into direct current energy, where the direct current energy may be stored or used to operate a load device.

### BRIEF DESCRIPTION OF THE DRAWINGS

FIG. 1 illustrates a system that demonstrates the concept of surface electromagnetic waves (SEWs), in accordance with one or more implementations.

FIG. 2 shows a transmitter-side view of a wireless energy setup which supports techniques for battery charging in non-line-of-sight configurations in accordance with various aspects of the present disclosure.

FIG. 3 shows a receiver-side view of a wireless energy setup which supports techniques for battery charging in non-line-of-sight configurations in accordance with various aspects of the present disclosure.

FIG. 4 shows a block diagram of an apparatus that supports battery charging in non-line-of-sight configurations in accordance with various aspects of the present disclosure.

FIG. 5 shows a block diagram of a battery charging component that supports battery charging in non-line-of-sight configurations in accordance with various aspects of the present disclosure.

FIG. 6 shows a diagram of a system including a device that supports battery charging in non-line-of-sight configurations in accordance with various aspects of the present disclosure.

FIGS. 7 and 8 show flowcharts illustrating methods that support battery charging in non-line-of-sight configurations in accordance with various aspects of the present disclosure.

### DETAILED DESCRIPTION

Devices, apparatuses, systems, and methods that support techniques for battery charging in non-line-of-sight configurations (e.g., through metal shields and obstacles and around corners) are disclosed. In some examples, conventional battery charging systems are ineffective in environments where direct line-of-sight transmission is obstructed by metal shields or physical obstacles. These systems rely on free-space radio frequency signals, which may be attenuated or completely blocked by conductive materials and complex geometries. This limitation may pose significant challenges for applications requiring reliable energy delivery to devices located in shielded or obstructed environments, such as industrial sensors, medical implants, or equipment in confined spaces. The inability to transmit energy through metal barriers or around obstacles may restrict operational flexibility and create inefficiencies in scenarios where continuous and reliable energy delivery is essential. Existing solutions may fail to address these challenges, leaving a gap in the field of battery charging technology.

According to some implementations, wireless energy systems may utilize antennas designed to generate surface-bound electromagnetic waves. These antennas, referred to as plasmonic antennas, may induce electromagnetic waves that travel along the surfaces of conductive materials, such as metals, and may bypass obstacles, barriers, corners, and/or other non-line-of-sight configurations. The antennas may be integrated onto flexible substrates, which may allow them to conform to various surfaces, including curved or irregular geometries.

Some implementations may include a transmitter configured to emit surface-bound electromagnetic waves. The transmitter may include a plasmonic antenna connected to a signal generator that produces radio frequency signals at specific frequencies. These signals may be amplified using a energy amplifier to increase their strength before being transmitted through the plasmonic antenna. The electromagnetic waves generated by the transmitter may propagate along the surface of conductive materials, such as metal shields, and may travel around obstacles or corners to reach areas that are not directly visible from the transmitter.

On the receiving side, some implementations may include a receiver designed to capture the surface-bound electromagnetic waves. The receiver may include a plasmonic antenna positioned on the opposite side of the conductive material or obstacle. The captured waves may be processed by a energy harvester board, which may include a rectifier to convert the received radio frequency signals into direct current energy. The direct current energy may be stored in energy storage components, such as batteries or capacitors, or may be used immediately to operate devices, such as light-emitting diodes.

Some implementations may include a control unit that may manage and synchronize the operations of the transmitter and receiver. The control unit may coordinate the signal generator, energy amplifier, and plasmonic antennas to optimize the efficiency of battery charging. This synchronization may ensure reliable delivery of energy through conductive materials and around obstacles.

The wireless energy systems described in some implementations may utilize surface-bound electromagnetic waves to transmit energy in environments where conventional systems relying on free-space transmission may be ineffective. These electromagnetic waves may propagate along the surfaces of conductive materials, enabling energy delivery to areas that are obstructed or shielded. This propagation mechanism may allow the systems to overcome barriers that would otherwise block traditional radio frequency signals.

Some implementations may include components such as signal generators for producing radio frequency signals, energy amplifiers for increasing signal strength, plasmonic antennas for inducing and capturing surface-bound electromagnetic waves, energy harvester boards for converting signals into direct current energy, and energy storage components for storing the converted energy. The antennas may be integrated onto flexible substrates, which may allow deployment on various surfaces, including those with complex geometries.

Some implementations may demonstrate the ability to transmit energy wirelessly through conductive materials, such as metal shields, and around obstacles. For example, a demonstration may involve a transmitter connected to a energy amplifier and plasmonic antenna on one side of a conductive shield. On the opposite side, a receiver with a plasmonic antenna and energy harvester may successfully convert the transmitted energy into direct current energy sufficient to operate a device, such as a light-emitting diode.

The systems described in some implementations may support applications requiring energy delivery to devices located in obstructed or shielded environments. Examples may include sensors in industrial settings, medical devices, or equipment in confined spaces. The flexible substrate integration may enhance adaptability to diverse deployment scenarios, allowing the systems to function in environments with curved or irregular surfaces.

Some implementations may provide energy conversion capabilities, where the receiver may process the captured electromagnetic waves to produce direct current energy. This energy may be stored in components such as batteries or capacitors for later use or may be used immediately to operate devices. The systems may also include mechanisms to ensure synchronization between the transmitter and receiver, which may maximize the efficiency of energy transmission.

The systems described in some implementations may be scalable and adaptable to different operational requirements. The flexible substrate integration and surface-bound wave propagation mechanism may allow deployment in various environments, including those with conductive barriers or complex geometries. These systems may demonstrate the ability to deliver energy wirelessly in scenarios where conventional systems relying on free-space transmission may face limitations.

Aspects of the subject matter described in this disclosure can be implemented to realize one or more of the following potential advantages. The described techniques may be implemented to support battery charging in environments where electromagnetic interference may otherwise disrupt conventional systems. The use of surface-bound electromagnetic waves may enable energy delivery with reduced signal attenuation compared to free-space transmission in obstructed settings. The integration of antennas onto flexible substrates may allow deployment on surfaces with irregular geometries, which may enhance compatibility with diverse operational conditions. The systems may provide a scalable solution for applications requiring reliable energy delivery across conductive barriers, which may improve the functionality of devices in shielded environments. The synchronization mechanisms between the transmitter and receiver may optimize energy transfer efficiency, which may reduce energy losses during transmission.

Aspects of the disclosure are initially described in the context of wireless energy systems. Aspects of the disclosure are additionally illustrated by and described with reference to example implementations. Aspects of the disclosure are further illustrated by and described with reference to a flowchart that relates to methods involving battery charging in non-line-of-sight configurations.

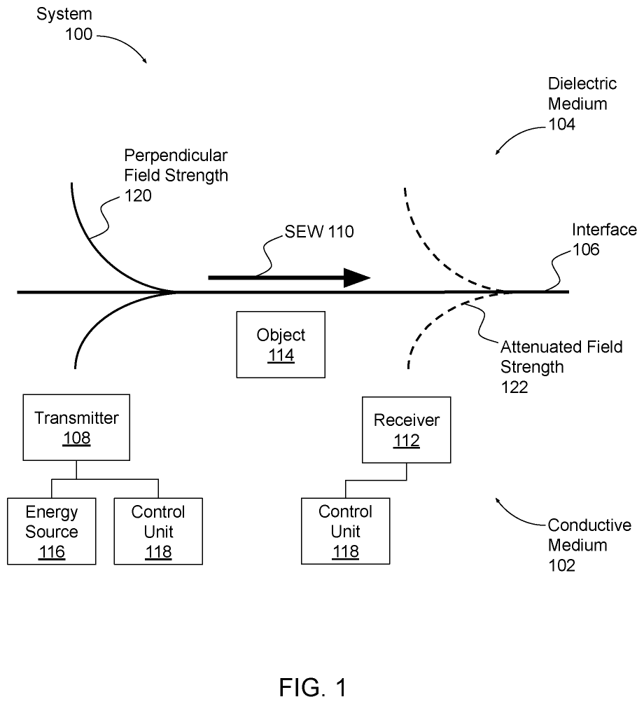

FIG. 1 illustrates a system 100 that demonstrates the concept of surface electromagnetic waves (SEWs), in accordance with one or more implementations. The system 100 may include a conductive medium 102, such as a body of water, organic tissue, a metallic plane, and/or other conductive media. Adjacent to the conductive medium 102, there may be a dielectric medium 104, such as air and/or other dielectric media, which may interface with the conductive medium 102. The interface 106 between the conductive medium 102 and the dielectric medium 104 may be where SEWs are generated and may propagate.

The system 100 may also include a transmitter 108, which may be positioned near the interface 106. The transmitter 108 may be positioned within the conductive medium 102 or within the dielectric medium 104. The transmitter 108 may be responsible for generating an electromagnetic field that may induce SEWs at the interface 106 of the conductive medium 102 and the dielectric medium 104. The excited SEWs may then travel along the interface 106, as indicated by the arrow of SEW 110, which may represent the direction of wave propagation.

To help visualize the phenomenon of SEWs, one may consider an analogy to ripples on a pond. When a stone is dropped into a still pond, ripples may form and spread out across the surface of the water. Similarly, the transmitter 108 may be thought of as the stone, and the SEWs may be akin to the ripples that spread along the conductive medium 102. Just as the ripples may move outward from the point of impact, SEWs may propagate along the interface 106, carrying energy with them.

The system 100 may further include a receiver 112, which may be positioned at a distance from the transmitter 108 along the interface 106. The receiver 112 may be positioned within the conductive medium 102 or within the dielectric medium 104. The receiver 112 may be configured to receive the SEWs after they have propagated along the interface 106. This may be analogous to placing one's hand in the water at a distance from where the stone was dropped, feeling the ripples as they pass by.

Additionally, the system 100 may include an object 114 positioned within the conductive medium 102 or within the dielectric medium 104, which may be representative of an obstacle that SEWs may encounter during propagation. The interaction of SEWs with the object 114 may lead to scattering of waves, similar to how water ripples may change direction or form patterns when they encounter a leaf or a rock in the pond.

The system 100 may include an energy source 116, such as a radio frequency generator, which may be connected to the transmitter 108. The energy source 116 may provide the necessary energy for the transmitter 108 to generate the electromagnetic fields that excite the SEWs. This may be thought of as the force with which the stone is thrown into the pond, affecting the size and strength of the resulting ripples.

In some implementations, the system 100 may include a control unit 118, which may be operatively coupled to the transmitter 108 and/or the receiver 112. The control unit 118 may be responsible for coordinating the generation and detection of SEWs, much like a person orchestrating the timing of stones being dropped into the pond to create a specific pattern of ripples.

From a more technical perspective, SEWs may be understood as a type of wave that propagates along the interface between two media with different dielectric properties. In FIG. 1, the conductive medium 102 and the dielectric medium 104 may form such an interface (e.g., interface 106) where SEWs may be excited and propagate. The transmitter 108 may serve as a transducer that converts electrical signals from the energy source 116 into electromagnetic fields, which may then couple to the interface 106 and give rise to SEWs.

The propagation of SEWs along the interface 106 may be characterized by a wave vector that is parallel to the interface 106. This wave vector may be larger than the wave vector of free photons in the dielectric medium 104, which may result in a confinement of the electromagnetic field to the vicinity of the interface 106. The SEW's field strength may decay exponentially in the direction perpendicular to the interface 106, as illustrated by a field strength 120 extending into the dielectric medium 104 and the conductive medium 102. These field strengths may also decay as the SEW propagates along the interface 106, as illustrated by an attenuated field strength 122. The receiver 112 may be designed to couple to these confined, attenuated fields and receive the SEWs after they have propagated along the interface 106.

The excitation of SEWs by the transmitter 108 may involve the conversion of the electromagnetic energy into a surface-bound mode, which may be facilitated by the specific design of the transmitter 108. The transmitter 108 may be optimized to match the impedance of the SEWs to maximize energy transfer into the surface wave mode. The object 114 submerged within the conductive medium 102 may introduce perturbations in the SEWs, which may be detected by the receiver 112 and analyzed by the control unit 118 to infer properties of the object 114. Examples of such properties may include one or more of size, shape, location, material properties, and/or other properties.

The mathematical description of SEWs may be derived from Maxwell's equations, which govern the properties of electromagnetic fields. The wave equation for TM-polarized SEWs may be reduced to a one-dimensional Schrödinger equation:

$$\frac{{d}^{2} ψ}{d {z}^{2}} + ( {k}^{2} - V ( z ) ) ψ = 0 \qquad ( EQN . 1 )$$

where y is the effective wave function introduced as E_{z}=ψ/\sqrt{∈}, and V(z) is the effective potential energy that guides the propagation of SEWs along the interface. The term k² may represent the total energy of the SEWs and the term e may represent the dielectric permittivity of the medium.

For TE-polarized SEWs, the wave equation may not depend on the gradient term V(z) and may be expressed as:

$$\frac{{d}^{2} {E}_{z}}{d {z}^{2}} + {k}^{2} {E}_{z} = 0 \qquad ( EQN . 2 )$$

In the case of a sharp interface between two media with dielectric permittivities ∈₁ and ∈₂, the SEW wave vector for TM-polarized waves may be given by:

$${k}_{SEW} = \sqrt{\frac{{ω}^{2}}{{c}^{2}} \frac{{ϵ}_{1} {ϵ}_{2}}{{ϵ}_{1} + {ϵ}_{2}}} \qquad ( EQN . 3 )$$

where ω is the angular frequency of the SEWs, and c is the speed of light in vacuum.

V_{z} The presence of dielectric permittivity gradients across the interface 106 may lead to additional terms in the effective potential, which may result in the formation of a potential well that supports bound states of SEWs. These bound states may correspond to surface modes with long propagation lengths and may be excited by the transmitter 108 with appropriate impedance matching.

The system 100 may thus utilize SEWs for various applications, including communication and sensing, by exploiting the unique properties of SEWs at the interface 106 between the conductive medium 102 and the dielectric medium 104. The control unit 118 may process the received signals to extract information about the propagation and interaction of SEWs with the environment and objects within it.

In some implementations, the transmitter 108 and/or the receiver 112 may include one or more plasmonic antennas. A given plasmonic antenna may be the same as or similar to, or include one or more aspects of, the antennas disclosed in U.S. patent application Ser. No. 17/570,968 entitled “Apparatus, Methods and Systems for Electromagnetic Signal Transmission Through a Conductive Medium” filed on Jan. 7, 2022; International Application No. PCT/US2024/061379 entitled “Surface Electromagnetic Wave Antenna” filed on Dec. 20, 2024; and International Patent Application No. PCT/US2025/015358 entitled “Hybrid Antenna With Dynamic Signal Routing For Free-Space And Near-Metal Environments” filed on Feb. 11, 2025, of which the entirety is incorporated by reference for all purposes.

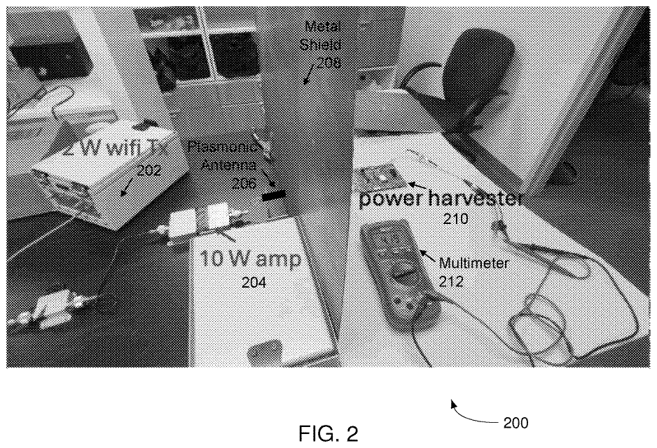

FIG. 2 shows a transmitter-side view of a wireless energy setup 200 which supports techniques for battery charging in non-line-of-sight configurations (e.g., through a metal door or wall panel, around a corner, etc.) in accordance with various aspects of the present disclosure. As depicted in FIG. 2, the wireless energy setup 200 may include one or more of a WIFI TX 202 (e.g., an RF signal generator), a 10 W AMP 204 (e.g., a energy amplifier), a plasmonic antenna 206, metal shield 208, a energy harvester 210, a multimeter 212, and/or other components.

The WIFI TX 202 may include a transmitter capable of generating wireless signals for battery charging. The WIFI TX 202 may be connected to an RF signal generator that produces a radio frequency signal at a specified frequency. The WIFI TX 202 may be used to induce surface electromagnetic waves along a conductive surface. In some implementations, the WIFI TX 202 may be integrated onto flexible substrates, allowing for conformal placement on various surfaces, including curved or irregular geometries.

The 10 W AMP 204 may include an amplifier configured to increase the strength of the transmitted signal. The 10 W AMP 204 may be connected to the WIFI TX 202 to amplify the RF signal before it is fed into the plasmonic antenna. The 10 W AMP 204 may ensure that the signal strength is sufficient to induce surface electromagnetic waves that can propagate along the surface of a metal shield or obstacle. In some implementations, the 10 W AMP 204 may be used in conjunction with other energy amplifiers to achieve the desired signal strength.

The plasmonic antenna 206 may include features that support the induction and propagation of surface electromagnetic waves. The plasmonic antenna 206 may be integrated onto a flexible substrate, which may allow it to conform to curved or irregular surfaces. The plasmonic antenna 206 may operate by coupling radio frequency signals into surface electromagnetic waves that propagate along conductive surfaces. The plasmonic antenna 206 may be connected to an RF signal generator and a energy amplifier to ensure sufficient signal strength for inducing surface electromagnetic waves. In some implementations, the plasmonic antenna 206 may be fabricated using materials such as gold or silver, which may exhibit plasmonic properties.

The metal shield 208 may represent a barrier around which surface electromagnetic waves can propagate. The metal shield 208 may be composed of conductive materials such as copper or aluminum, which may support the propagation of surface electromagnetic waves along their surfaces. The metal shield 208 may serve as an obstacle that blocks conventional free-space RF transmission, but it may allow surface electromagnetic waves to travel around or through it. The interaction between the plasmonic antenna 208 and the metal shield 208 may enable the transmission of energy in non-line-of-sight configurations. In some implementations, the metal shield 208 may take the form of a flat plate, a curved surface, or a complex geometry, depending on the application.

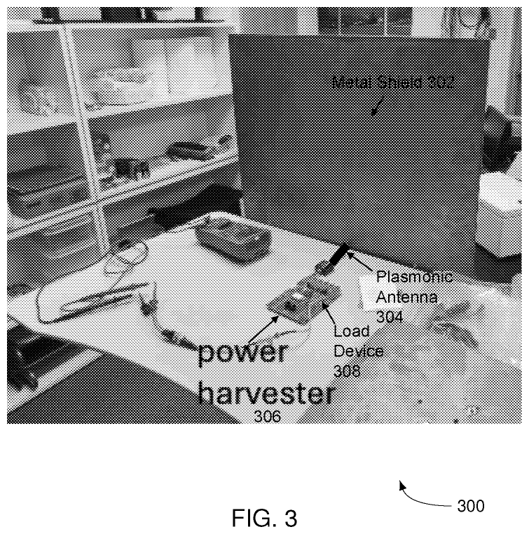

The energy harvester 210 may include a component designed to capture and convert received signals into usable electrical energy. The energy harvester 210 may be connected to a receiver plasmonic antenna (see, e.g., plasmonic antenna 304 in FIG. 3) to capture the surface electromagnetic waves propagating along the conductive surface. The energy harvester 210 may include a rectifier to convert the RF signal into DC energy, which can be stored in an energy storage component or used to operate a small load device. In some implementations, the energy harvester 210 may be integrated with other energy storage components, such as batteries or capacitors.

The multimeter 212 may include a device capable of measuring electrical parameters such as voltage or current. The multimeter 212 may be used to measure the output of the energy harvester 210 to determine the efficiency of the battery charging system. The multimeter 212 may be connected to the energy storage component or the small load device to monitor the electrical parameters during the operation of the system. In some implementations, the multimeter 212 may be used in conjunction with other monitoring devices to provide comprehensive data on the system's performance.

In some implementations, the Wi-Fi TX 202 may generate a radio frequency signal that is amplified by the 10 W AMP 204 to increase signal strength before being transmitted through the plasmonic antenna 206. The amplified signal may induce surface electromagnetic waves on the metal shield 208, which may propagate along its surface toward the opposite side. The energy harvester 210 may capture these surface electromagnetic waves through its connected plasmonic antenna (see, e.g., plasmonic antenna 304 in FIG. 3) and may convert the received signal into direct current energy. The multimeter 212 may measure the output voltage generated by the energy harvester 210 to determine the electrical energy available for operating connected devices.

FIG. 3 shows a receiver-side view of a wireless energy setup 300 which supports techniques for battery charging in non-line-of-sight configurations in accordance with various aspects of the present disclosure. As depicted in FIG. 3, the wireless energy setup 300 may include one or more of a metal shield 302, a plasmonic antenna 304, a energy harvester 306, a load device 308, and/or other components.

The metal shield 302 may represent a barrier around which surface electromagnetic waves can propagate. In some implementations, the metal shield 302 may be the same as or similar to the metal shield 208, as described herein.

The plasmonic antenna 304 may include features that support the generation and propagation of surface electromagnetic waves. The plasmonic antenna 304 may be integrated onto a flexible substrate, which may allow it to conform to curved or irregular surfaces. The plasmonic antenna 304 may operate by coupling radio frequency signals into surface electromagnetic waves that propagate along conductive surfaces. In some implementations, the plasmonic antenna 304 may be fabricated using materials such as gold or silver, which may exhibit plasmonic properties. The interaction between the plasmonic antenna 304 and the metal shield 302 may enable the transmission of energy in non-line-of-sight configurations.

The energy harvester 306 may include components that convert received electromagnetic waves into usable electrical energy. In some implementations, the energy harvester 306 may be the same as or similar to the energy harvester 210, as described herein.

The load device 308 may represent an electrical component that operates using the energy harvested by the system. The load device 308 may include components such as LEDs, sensors, or small electronic devices that may require low energy to function. The load device 308 may be connected to the energy harvester 306 to receive the rectified DC energy generated from the captured surface electromagnetic waves. The load device 308 may demonstrate the functionality of the system in converting transmitted energy into usable energy. In some implementations, the load device 308 may be replaced with alternative components such as microcontrollers or wireless communication modules, depending on the specific use case.

In some implementations, a plasmonic antenna (e.g., plasmonic antenna 206) may be positioned adjacent to the RF signal generator and energy amplifier on the transmitting side, allowing it to induce surface electromagnetic waves that propagate along the surface of the metal shield 302. The metal shield 302 may serve as the conductive medium along which the surface electromagnetic waves travel, guiding the energy around obstacles to the receiving side. The energy harvester 306 may be connected to the receiving plasmonic antenna 304, which may capture the transmitted surface electromagnetic waves and convert them into an electrical signal.

In some implementations, the energy harvester 306 may include a rectifier circuit that may process the captured signal to produce a direct current output. This output may then be directed to the load device 308, which may be configured to operate using the harvested energy. The components may be arranged such that the plasmonic antenna 304 on the receiving side is aligned with the surface of the metal shield 302 to maximize the capture of surface electromagnetic waves, while the energy harvester 306 may be positioned to efficiently transfer the converted energy to the load device 308.

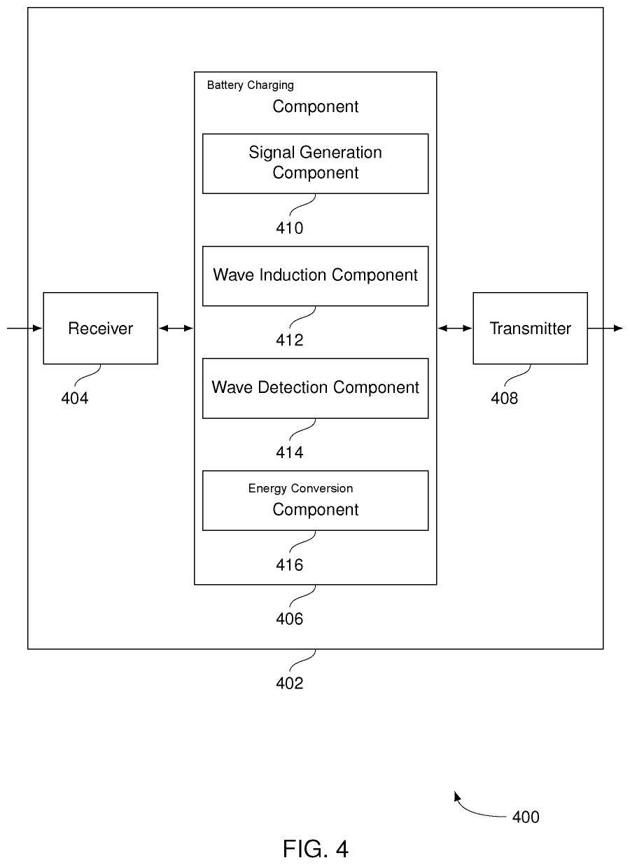

FIG. 4 shows a block diagram 400 of an apparatus 402 that supports battery charging in non-line-of-sight configurations in accordance with various aspects of the present disclosure. The apparatus 402 may be the same as or similar to one or more components described in connection with the environment 100 of FIG. 1. The apparatus 402 may include an input module 404, battery charging component 406, and an output module 408. The apparatus 402 may also include a processor. Each of these components may be in communication with one another (e.g., via one or more buses). In some cases, the apparatus 402 may be an example of a user terminal, a database server, or a system containing multiple computing devices.

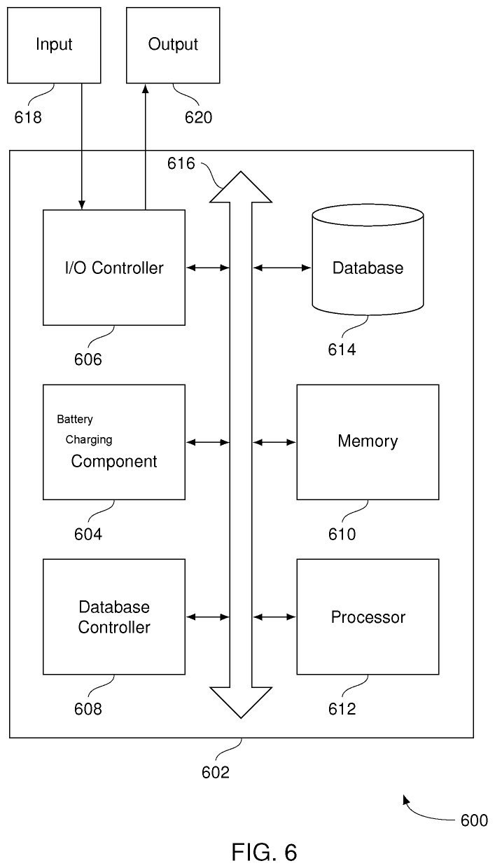

The input module 404 may manage input signals for the apparatus 402. For example, the input module 404 may identify input signals based on an interaction with a modem, a keyboard, a mouse, a touchscreen, or a similar device. These input signals may be associated with user input or processing at other components or devices. In some cases, the input module 404 may utilize an operating system such as iOS®, ANDROID®, MS-DOS®, MS-WINDOWS®, OS/2®, UNIX®, LINUX®, or another known operating system to handle input signals. The input module 404 may send aspects of these input signals to other components of the apparatus 402 for processing. In some cases, the input module 404 may be a component of an input/output (I/O) controller 606 as described with reference to FIG. 6.

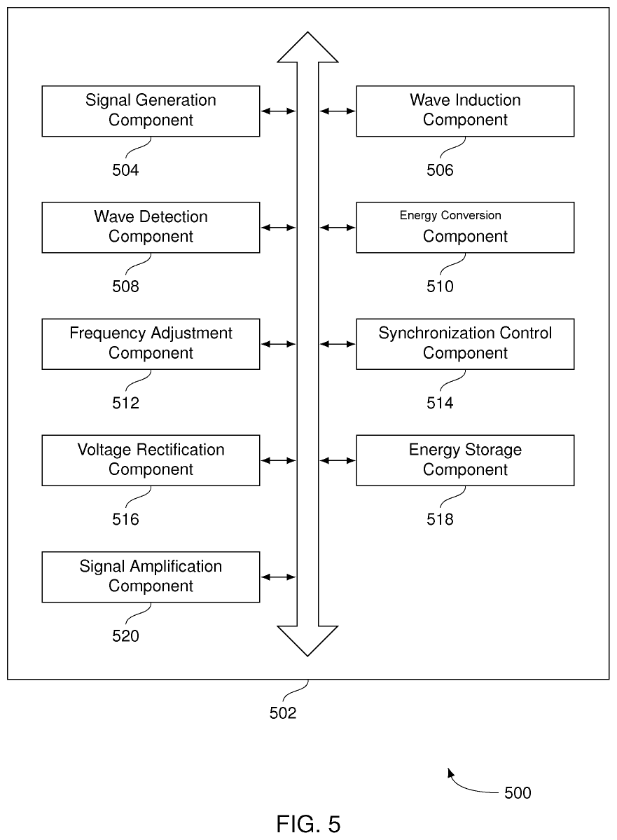

The battery charging component 406 may include one or more of a signal generation component 410, a wave induction component 412, a wave detection component 414, a energy conversion component 416, and/or other components. The battery charging component 406 may be an example of aspects of the battery charging component 502 or 604 described with reference to FIGS. 5 and 6.

The signal generation component 410 may be configured as or otherwise support a means for generating a radio frequency signal at a specified frequency using a signal generator connected to a plasmonic antenna configured as a transmitter. The wave induction component 412 may be configured as or otherwise support a means for inducing surface electromagnetic waves along a metal surface in response to the radio frequency signal, wherein the surface electromagnetic waves may propagate around obstacles to reach a receiver. The wave detection component 414 may be configured as or otherwise support a means for detecting the surface electromagnetic waves at the receiver, wherein the receiver may include a second plasmonic antenna connected to a energy harvester board. The energy conversion component 416 may be configured as or otherwise support a means for converting the captured surface electromagnetic waves into direct current energy, wherein the direct current energy may be stored or used to operate a load device.

The output module 408 may manage output signals for the apparatus 402. For example, the output module 408 may receive signals from other components of the apparatus 402, such as the battery charging component 406, and may transmit these signals to other components or devices. In some specific examples, the output module 408 may transmit output signals for display in a user interface, for storage in a database or data store, for further processing at a server or server cluster, or for any other processes at any number of devices or systems. In some cases, the output module 408 may be a component of an I/O controller 606 as described with reference to FIG. 6.

FIG. 5 shows a block diagram 500 of a battery charging component 502 that supports battery charging in non-line-of-sight configurations in accordance with various aspects of the present disclosure. The battery charging component 502 may be an example of aspects of a battery charging component 406, a battery charging component 604, or both, as described herein. The battery charging component 502, or various components thereof, may be an example of means for performing various aspects of battery charging in non-line-of-sight configurations as described herein. For example, the battery charging component 502 may include one or more of a signal generation component 504, a wave induction component 506, a wave detection component 508, a energy conversion component 510, a frequency adjustment component 512, a synchronization control component 514, a voltage rectification component 516, an energy storage component 518, a signal amplification component 520, and/or other components. Each of these components may communicate, directly or indirectly, with one another (e.g., via one or more buses).

The signal generation component 504 may be configured as or otherwise support a means for generating a radio frequency signal at a specified frequency using a signal generator connected to a plasmonic antenna configured as a transmitter. In some implementations, the signal generation component 504 may include a tunable oscillator to adjust the frequency based on the application requirements. The signal generation component 504 may be integrated with a frequency synthesizer to ensure precise frequency control. The signal generation component 504 may be housed in a shielded enclosure to minimize electromagnetic interference. The signal generation component 504 may be powered by a dedicated energy supply to maintain consistent performance.

The wave induction component 506 may be configured as or otherwise support a means for inducing surface electromagnetic waves along a metal surface in response to the radio frequency signal, the surface electromagnetic waves may propagate around obstacles to reach a receiver. In some implementations, the wave induction component 506 may include a plasmonic antenna designed to couple with the metal surface to initiate the propagation of surface electromagnetic waves. The wave induction component 506 may be integrated onto a flexible substrate, which may conform to curved or irregular surfaces to accommodate various deployment scenarios. The wave induction component 506 may operate at a frequency range determined by the material properties of the metal surface to ensure compatibility with the propagation of surface electromagnetic waves. In some implementations, the wave induction component 506 may include a mechanism to adjust the coupling strength between the plasmonic antenna and the metal surface to account for variations in surface conductivity. The wave induction component 506 may be positioned in proximity to the metal surface to maintain effective induction of surface electromagnetic waves.

The wave detection component 508 may be configured as or otherwise support a means for detecting the surface electromagnetic waves at the receiver, the receiver may include a second plasmonic antenna connected to a energy harvester board. In some implementations, the wave detection component 508 may include a mechanism to adjust the orientation of the second plasmonic antenna to align with the direction of the incoming surface electromagnetic waves. The wave detection component 508 may incorporate a shielding layer around the second plasmonic antenna to minimize interference from ambient electromagnetic signals. In some implementations, the wave detection component 508 may include a calibration module to determine the optimal positioning of the second plasmonic antenna relative to the metal surface. The wave detection component 508 may be designed to operate across a range of frequencies to accommodate variations in the transmitted surface electromagnetic waves.

The energy conversion component 510 may be configured as or otherwise support a means for converting the captured surface electromagnetic waves into direct current energy, the direct current energy may be stored or used to operate a load device. In some implementations, the energy conversion component 510 may include a rectifier circuit designed to convert alternating current signals from the surface electromagnetic waves into direct current energy. In some implementations, the energy conversion component 510 may incorporate a voltage regulator to maintain a consistent output voltage suitable for powering sensitive electronic devices. In some implementations, the energy conversion component 510 may include an energy storage module, such as a rechargeable battery or capacitor, to temporarily store the direct current energy for later use. In some implementations, the energy conversion component 510 may feature multiple output terminals to distribute the direct current energy to different load devices simultaneously. In some implementations, the energy conversion component 510 may include a monitoring system to determine the efficiency of the energy conversion process under varying input conditions.

In some examples, the frequency adjustment component 512 may be configured as or otherwise support a means for adjusting the frequency of the radio frequency signal in response to detecting variations in the propagation environment to maintain efficient battery charging. In some implementations, the frequency adjustment component 512 may include a sensor array to determine changes in environmental factors such as temperature or humidity that may affect signal propagation. In some implementations, the frequency adjustment component 512 may incorporate a feedback loop to dynamically modify the signal frequency based on real-time data from the propagation environment.

In some implementations, the frequency adjustment component 512 may feature a programmable interface that may allow users to manually set frequency ranges suitable for specific deployment scenarios. In some implementations, the frequency adjustment component 512 may include a memory module to store historical frequency adjustments that may be referenced to predict future changes in the propagation environment. In some implementations, the frequency adjustment component 512 may integrate with external monitoring systems that may provide additional data inputs to refine frequency adjustments.

In some examples, the synchronization control component 514 may be configured as or otherwise support a means for coordinating the operation of the signal generator, energy amplifier, and plasmonic antennas with a control unit to synchronize the transmission and reception of the surface electromagnetic waves. In some implementations, the synchronization control component 514 may include a timing module that may determine the precise intervals for activating the signal generator and energy amplifier. In some implementations, the synchronization control component 514 may feature a communication interface that may allow the control unit to send real-time adjustments to the plasmonic antennas. In some implementations, the synchronization control component 514 may incorporate a feedback mechanism that may monitor the performance of the transmission and reception processes. In some implementations, the synchronization control component 514 may be integrated with a diagnostic system that may determine any discrepancies in the synchronization process. In some implementations, the synchronization control component 514 may include a programmable logic controller that may allow for custom synchronization protocols based on specific deployment scenarios.

In some examples, the voltage rectification component 516 may be configured as or otherwise support a means for rectifying the direct current energy at the energy harvester to provide a stable voltage output for operating the load device. In some implementations, the voltage rectification component 516 may include a multi-stage rectifier circuit to handle varying input energy levels effectively. In some implementations, the voltage rectification component 516 may incorporate a filtering mechanism to reduce noise in the rectified output voltage. In some implementations, the voltage rectification component 516 may feature adjustable parameters to accommodate different load device requirements.

In some examples, the energy storage component 518 may be configured as or otherwise support a means for storing the direct current energy in an energy storage component selected from the group including a battery and a capacitor for later use. In some implementations, the energy storage component 518 may include a lithium-ion battery that may be rechargeable to accommodate repeated cycles of energy storage and discharge. In some implementations, the energy storage component 518 may feature a supercapacitor that may allow for rapid charging and discharging to support applications requiring quick energy transfer. In some implementations, the energy storage component 518 may incorporate a thermal management system that may regulate the temperature of the battery or capacitor to maintain consistent performance. In some implementations, the energy storage component 518 may include a modular design that may allow for the replacement or expansion of storage units based on specific energy requirements.

In some examples, the signal amplification component 520 may be configured as or otherwise support a means for amplifying the radio frequency signal generated by the signal generator with a energy amplifier to increase signal strength prior to inducing the surface electromagnetic waves along the metal surface. In some implementations, the signal amplification component 520 may include a variable gain control mechanism that may allow adjustments to the amplification level based on the propagation environment. In some implementations, the signal amplification component 520 may feature a cooling system that may regulate the temperature of the energy amplifier during operation to maintain consistent performance. In some implementations, the signal amplification component 520 may incorporate a shielding enclosure that may reduce electromagnetic interference from external sources during signal amplification.

FIG. 6 shows a diagram of a system 600 including a device 602 that supports battery charging in non-line-of-sight configurations in accordance with aspects of the present disclosure. The device 602 may be an example of or include the components of a database server or an apparatus 402 as described herein. The device 602 may include components for bi-directional data communications including components for transmitting and receiving communications, including a battery charging component 604, an I/O controller 606, a database controller 608, memory 610, a processor 612, and a database 614. These components may be in electronic communication via one or more buses (e.g., bus 616).

The battery charging component 604 may be an example of a battery charging component 406 or 502 as described herein. For example, the battery charging component 604 may perform any of the methods or processes described above with reference to FIGS. 4 and 5. In some cases, the battery charging component 604 may be implemented in hardware, software executed by a processor, firmware, or any combination thereof.

The I/O controller 606 may manage input signals 618 and output signals 620 for the device 602. The I/O controller 606 may also manage peripherals not integrated into the device 602. In some cases, the I/O controller 606 may represent a physical connection or port to an external peripheral. In some cases, the I/O controller 606 may utilize an operating system such as iOS®, ANDROID®, MS-DOS®, MS-WINDOWS®, OS/2®, UNIX®, LINUX®, or another known operating system. In other cases, the I/O controller 606 may represent or interact with a modem, a keyboard, a mouse, a touchscreen, or a similar device. In some cases, the I/O controller 606 may be implemented as part of a processor. In some cases, a user may interact with the device 602 via the I/O controller 606 or via hardware components controlled by the I/O controller 606.

The database controller 608 may manage data storage and processing in a database 614. In some cases, a user may interact with the database controller 608. In other cases, the database controller 608 may operate automatically without user interaction. The database 614 may be an example of a single database, a distributed database, multiple distributed databases, a data store, a data lake, or an emergency backup database.

Memory 610 may include random-access memory (RAM) and read-only memory (ROM). The memory 610 may store computer-readable, computer-executable software including instructions that, when executed, cause the processor to perform various functions described herein. In some cases, the memory 610 may contain, among other things, a basic input/output system (BIOS) which may control basic hardware or software operation such as the interaction with peripheral components or devices.

The processor 612 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 612 may be configured to operate a memory array using a memory controller. In other cases, a memory controller may be integrated into the processor 612. The processor 612 may be configured to execute computer-readable instructions stored in a memory 610 to perform various functions (e.g., functions or tasks supporting wireless power transmission in non-line-of-sight configurations).

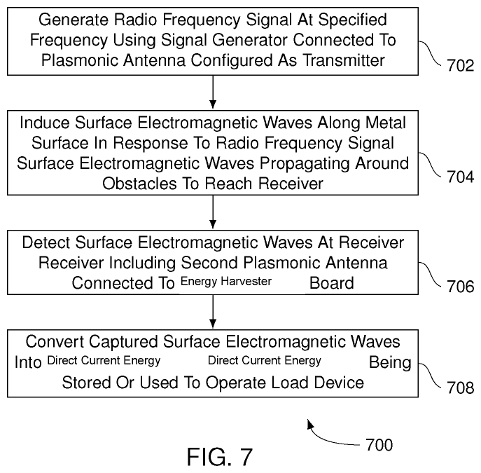

FIG. 7 shows a flowchart illustrating a method 700 that supports wireless power transmission in non-line-of-sight configurations in accordance with various aspects of the present disclosure. The operations of the methods described herein may be implemented by one or more of a device, an apparatus, a system (e.g., a networked computing system), and/or components thereof as described herein. For example, the operations of the method 700 may be performed by a wireless power transmission component as described with reference to FIGS. 4 through 6. In some examples, one or more components of a device, apparatus, and/or system may execute a set of instructions to control the functional elements of the component(s) to perform the described functions. Additionally or alternatively, the one or more components of a device, apparatus, and/or system may perform aspects of the described functions using special-purpose hardware.

At 702, the method 700 may include generating a radio frequency signal at a specified frequency using a signal generator connected to a plasmonic antenna configured as a transmitter. The operations of 702 may be performed in accordance with examples as disclosed herein. In some examples, aspects of the operations of 702 may be performed by a signal generation component 504 as described with reference to FIG. 5.

At 704, the method 700 may include inducing surface electromagnetic waves along a metal surface in response to the radio frequency signal, the surface electromagnetic waves propagating around obstacles to reach a receiver. The operations of 704 may be performed in accordance with examples as disclosed herein. In some examples, aspects of the operations of 704 may be performed by a wave induction component 506 as described with reference to FIG. 5.

At 706, the method 700 may include detecting the surface electromagnetic waves at the receiver, the receiver including a second plasmonic antenna connected to a power harvester board. The operations of 706 may be performed in accordance with examples as disclosed herein. In some examples, aspects of the operations of 706 may be performed by a wave detection component 508 as described with reference to FIG. 5.

At 708, the method 700 may include converting the captured surface electromagnetic waves into direct current power, the direct current power being stored or used to operate a load device. The operations of 708 may be performed in accordance with examples as disclosed herein. In some examples, aspects of the operations of 708 may be performed by a power conversion component 510 as described with reference to FIG. 5.

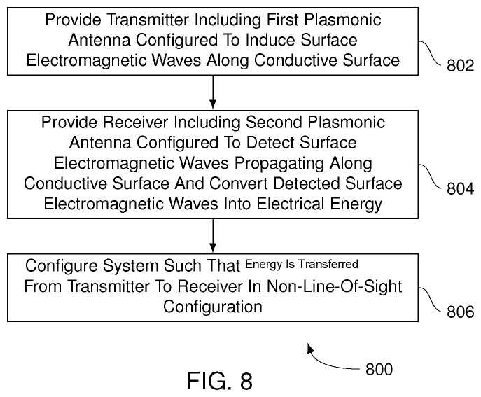

FIG. 8 shows a flowchart illustrating a method 800 involving wireless power systems in accordance with various aspects of the present disclosure.

At 802, the method 800 may include providing a transmitter including a first plasmonic antenna configured to induce surface electromagnetic waves along a conductive surface. The operations of 802 may be performed in accordance with examples as disclosed herein. In some examples, aspects of the operations of 802 may involve one or more of a WIFI TX 202, a 10 W AMP 204, a plasmonic antenna 206, and/or other components as described with reference to FIG. 2.

At 804, the method 800 may include providing a receiver including a second plasmonic antenna configured to detect the surface electromagnetic waves propagating along the conductive surface and convert the detected surface electromagnetic waves into electrical energy. The operations of 804 may be performed in accordance with examples as disclosed herein. In some examples, aspects of the operations of 804 may involve one or more of a plasmonic antenna 304, a power harvester 306, and/or other components as described with reference to FIG. 3.

At 806, the method 800 may include configuring the system such that power is transmitted from the transmitter to the receiver in a non-line-of-sight configuration. The operations of 806 may be performed in accordance with examples as disclosed herein. In some examples, aspects of the operations of 806 may involve one or more of a WIFI TX 202 (e.g., an RF signal generator), a 10 W AMP 204 (e.g., a power amplifier), a plasmonic antenna 206, a metal shield 302, a plasmonic antenna 304, a power harvester 306, a load device 308, and/or other components as described with reference to FIGS. 2 and 3.

It should be noted that the methods described herein describe possible implementations, and that the operations and the steps may be rearranged or otherwise modified and that other implementations are possible. Furthermore, aspects from two or more of the methods may be combined.

Aspect 1: A wireless power transmission system, comprising: a transmitter including a first plasmonic antenna configured to induce surface electromagnetic waves along a conductive surface; and a receiver including a second plasmonic antenna configured to detect the surface electromagnetic waves propagating along the conductive surface and convert the detected surface electromagnetic waves into electrical energy; wherein power is transmitted from the transmitter to the receiver in a non-line-of-sight configuration.

Aspect 2: The wireless power transmission system of aspect 1, further comprising a power harvester electrically connected to the second plasmonic antenna, the power harvester configured to store the electrical energy in an energy storage component.

Aspect 3: The wireless power transmission system of any of aspects 1 through 2, wherein the energy storage component comprises a battery or a capacitor.

Aspect 4: The wireless power transmission system of any of aspects 1 through 3, wherein the second plasmonic antenna is positioned on an opposite side of a conductive surface relative to the first plasmonic antenna.

Aspect 5: The wireless power transmission system of any of aspects 1 through 4, wherein the conductive surface comprises a metal shield configured to enable propagation of the surface electromagnetic waves induced by the first plasmonic antenna.

Aspect 6: The wireless power transmission system of any of aspects 1 through 5, further comprising a control unit electrically connected to one or both of the transmitter and/or the receiver, the control unit configured to synchronize operation between the first plasmonic antenna and the second plasmonic antenna.

Aspect 7: The wireless power transmission system of any of aspects 1 through 6, wherein the control unit is configured to adjust the frequency of the radio frequency signal generated by the transmitter.

Aspect 8: The wireless power transmission system of any of aspects 1 through 7, wherein the first plasmonic antenna and the second plasmonic antenna are integrated onto flexible substrates configured to conform to curved or irregular geometries.

Aspect 9: The wireless power transmission system of any of aspects 1 through 8, wherein the first plasmonic antenna is connected to a power amplifier configured to increase the strength of the radio frequency signal.

Aspect 10: The wireless power transmission system of any of aspects 1 through 9, wherein the second plasmonic antenna is connected to a rectifier configured to convert the detected surface electromagnetic waves into direct current power.

Aspect 11: The wireless power transmission system of any of aspects 1 through 10, wherein the control unit is configured to manage the operation of the RF signal generator and the power amplifier.

Aspect 12: The wireless power transmission system of any of aspects 1 through 11, wherein the first plasmonic antenna and the second plasmonic antenna are configured to operate at a specified frequency.

Aspect 13: The wireless power transmission system of any of aspects 1 through 12, wherein the conductive surface is configured to enable the surface electromagnetic waves to travel around obstacles or corners.

Aspect 14: The wireless power transmission system of any of aspects 1 through 13, wherein the power harvester is configured to directly use the electrical energy to operate a load device.

Aspect 15: A method of forming a wireless power transmission system, comprising: providing a transmitter including a first plasmonic antenna configured to induce surface electromagnetic waves along a conductive surface; and providing a receiver including a second plasmonic antenna configured to detect the surface electromagnetic waves propagating along the conductive surface and convert the detected surface electromagnetic waves into electrical energy; wherein the system is configured such that power is transmitted from the transmitter to the receiver in a non-line-of-sight configuration.

Aspect 16: A method for wireless power transmission in non-line-of-sight configurations, comprising: generating a radio frequency signal at a specified frequency using a signal generator connected to a plasmonic antenna configured as a transmitter; inducing surface electromagnetic waves along a metal surface in response to the radio frequency signal, the surface electromagnetic waves propagating around obstacles to reach a receiver; detecting the surface electromagnetic waves at the receiver, the receiver including a second plasmonic antenna connected to a power harvester board; and converting the captured surface electromagnetic waves into direct current power, the direct current power being stored or used to operate a load device.

Aspect 17: The method of aspect 16, further comprising: adjusting the frequency of the radio frequency signal in response to detecting variations in the propagation environment to maintain efficient power transmission.

Aspect 18: The method of any of aspects 16 through 17, further comprising: coordinating the operation of the signal generator, power amplifier, and plasmonic antennas with a control unit to synchronize the transmission and reception of the surface electromagnetic waves.

Aspect 19: The method of any of aspects 16 through 18, further comprising: rectifying the direct current power at the power harvester to provide a stable voltage output for operating the load device.

Aspect 20: The method of any of aspects 16 through 19, further comprising: storing the direct current power in an energy storage component selected from the group including a battery and a capacitor for later use.

Aspect 21: The method of any of aspects 16 through 20, further comprising: amplifying the radio frequency signal generated by the signal generator with a power amplifier to increase signal strength prior to inducing the surface electromagnetic waves along the metal surface.

Aspect 22: The method of any of aspects 16 through 21, wherein the plasmonic antenna configured as the transmitter is integrated onto a flexible substrate to conform to various surface geometries.

Aspect 23: The method of any of aspects 16 through 22, wherein the power harvester includes a voltage regulator to maintain a consistent output voltage for the load device.

Aspect 24: The method of any of aspects 16 through 23, wherein the control unit dynamically adjusts the power amplifier output in response to changes in the received signal strength at the receiver.

Aspect 25: The method of any of aspects 16 through 24, wherein the surface electromagnetic waves are induced at a frequency selected to minimize attenuation through the metal surface.

Aspect 26: The method of any of aspects 16 through 25, wherein the receiver includes a signal strength indicator to provide feedback on the efficiency of power transmission.

Aspect 27: The method of any of aspects 16 through 26, wherein the power harvester includes a filtering circuit to reduce noise in the rectified direct current power.

Aspect 28: The method of any of aspects 16 through 27, wherein the control unit periodically recalibrates the synchronization between the transmitter and receiver to account for environmental changes.

Aspect 29: A system for wireless power transmission in non-line-of-sight configurations, comprising a processor; memory coupled with the processor; and instructions stored in the memory and executable by the processor to cause the system to perform a method of any of aspects 16 through 28.

Aspect 30: A system for wireless power transmission in non-line-of-sight configurations, comprising at least one means for performing a method of any of aspects 16 through 28.

Aspect 31: A non-transitory computer-readable medium storing code for wireless power transmission in non-line-of-sight configurations, the code comprising instructions executable by a processor to perform a method of any of aspects 16 through 28.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A wireless power transmission system, comprising:
a transmitter including a first plasmonic antenna configured to induce surface electromagnetic waves along a conductive surface; and
a receiver including a second plasmonic antenna configured to detect the surface electromagnetic waves propagating along the conductive surface and convert the detected surface electromagnetic waves into electrical energy;
wherein power is transmitted from the transmitter to receiver in a non-line-of-sight configuration.

2. The wireless power transmission system of claim 1, further comprising a power harvester electrically connected to the second plasmonic antenna, the power harvester configured to store the electrical energy in an energy storage component.

3. The wireless power transmission system of claim 2, wherein the energy storage component comprises a battery or a capacitor.

4. The wireless power transmission system of claim 1, wherein the second plasmonic antenna is positioned on an opposite side of a conductive surface relative to the first plasmonic antenna.

5. The wireless power transmission system of claim 4, wherein the conductive surface comprises a metal shield configured to enable propagation of the surface electromagnetic waves induced by the first plasmonic antenna.

6. The wireless power transmission system of claim 1, further comprising a control unit electrically connected to one or both of the transmitter and/or the receiver, the control unit configured to synchronize operation between the first plasmonic antenna and the second plasmonic antenna.

7. The wireless power transmission system of claim 6, wherein the control unit is configured to adjust the frequency of the radio frequency signal generated by the transmitter.

8. The wireless power transmission system of claim 1, wherein the first plasmonic antenna and the second plasmonic antenna are integrated onto flexible substrates configured to conform to curved or irregular geometries.

9. The wireless power transmission system of claim 1, wherein the first plasmonic antenna is connected to a power amplifier configured to increase the strength of the radio frequency signal.

10. The wireless power transmission system of claim 1, wherein the second plasmonic antenna is connected to a rectifier configured to convert the detected surface electromagnetic waves into direct current power.

11. The wireless power transmission system of claim 1, wherein the control unit is configured to manage the operation of the RF signal generator and the power amplifier.

12. The wireless power transmission system of claim 1, wherein the first plasmonic antenna and the second plasmonic antenna are configured to operate at a specified frequency.

13. The wireless power transmission system of claim 1, wherein the conductive surface is configured to enable the surface electromagnetic waves to travel around obstacles or corners.

14. The wireless power transmission system of claim 1, wherein the power harvester is configured to directly use the electrical energy to operate a load device.

15. A method for wireless power transmission in non-line-of-sight configurations, comprising:
generating a radio frequency signal at a specified frequency using a signal generator connected to a plasmonic antenna configured as a transmitter;
inducing surface electromagnetic waves along a metal surface in response to the radio frequency signal, the surface electromagnetic waves propagating around obstacles to reach a receiver;
detecting the surface electromagnetic waves at the receiver, the receiver including a second plasmonic antenna connected to a power harvester board; and
converting the captured surface electromagnetic waves into direct current power, the direct current power being stored or used to operate a load device.

16. The method of claim 15, further comprising adjusting the frequency of the radio frequency signal in response to detecting variations in the propagation environment to maintain efficient power transmission.

17. The method of claim 15, further comprising coordinating the operation of the signal generator, power amplifier, and plasmonic antennas with a control unit to synchronize the transmission and reception of the surface electromagnetic waves.

18. The method of claim 15, further comprising rectifying the direct current power at the power harvester to provide a stable voltage output for operating the load device.

19. The method of claim 15, further comprising storing the direct current power in an energy storage component selected from the group including a battery and a capacitor for later use.

20. A system configured for wireless power transmission in non-line-of-sight configurations, comprising:
a processor;
memory coupled with the processor; and
instructions stored in the memory and executable by the processor to cause the system to:
generate a radio frequency signal at a specified frequency using a signal generator connected to a plasmonic antenna configured as a transmitter;
induce surface electromagnetic waves along a metal surface in response to the radio frequency signal, the surface electromagnetic waves propagating around obstacles to reach a receiver;
detect the surface electromagnetic waves at the receiver, the receiver including a second plasmonic antenna connected to a power harvester board; and
convert the captured surface electromagnetic waves into direct current power, the direct current power being stored or used to operate a load device.
